(19) United States
(12) Patent Application Publication
(10) Pub. No.: US 2022/0268590 A1
(43) Pub. Date: Aug. 25, 2022

(54) INFORMATION PROCESSING METHOD, INFORMATION PROCESSING DEVICE, AND NON-TRANSITORY STORAGE MEDIUM

(71) Applicant: TOYOTA JIDOSHA KABUSHIKI KAISHA, Toyota-shi (JP)

(72) Inventors: Ryo MURAKAMI, Susono-shi (JP); Yuji TACHIBANA, Nisshin-shi (JP); Minoru NAKADORI, Toyota-shi (JP); Daiki KANEICHI, Shinagawa-ku (JP)

(73) Assignee: TOYOTA JIDOSHA KABUSHIKI KAISHA, Toyota-shi (JP)

(21) Appl. No.: 17/668,720

(22) Filed: Feb. 10, 2022

(30) Foreign Application Priority Data
Feb. 19, 2021 (JP) 2021-025699

(51) Int. Cl. G01C 21/34; G01C 21/36

(52) U.S. Cl. CPC G01C 21/3438; G01C 21/3605; G01C 21/3492

(57) ABSTRACT

An information processing method executed by an information processing device includes acquiring a vehicle dispatch request from a user, via a terminal device, acquiring movement information regarding an amount of movement of the user, deciding a boarding position at which the user is to board a vehicle, based on a current position of the user and the movement information, and deciding an operation plan of the vehicle such that the vehicle heads for the boarding position.

### CROSS-REFERENCE TO RELATED APPLICATION

This application claims priority to Japanese Patent Application No. 2021-025699 filed on Feb. 19, 2021, incorporated herein by reference in its entirety.

### BACKGROUND

### 1. Technical Field

The present disclosure relates to an information processing method, an information processing device, and a non-transitory storage medium.

### 2. Description of Related Art

Conventionally, there is known technology for transporting passengers using a vehicle. For example, Japanese Unexamined Patent Application Publication No. 2019-106019 (JP 2019-106019 A) discloses an information processing device that acquires boarding position information regarding a position of a virtual boarding point that is a boarding point that is virtual, which is a boarding point for boarding a moving body, and when a user satisfies condition information indicating a condition regarding an action of the user approaching the virtual boarding point, notifies the user of information relating to the position indicated by the boarding position information.

### SUMMARY

There has been room for improvement in the technology for performing passenger transportation using vehicles.

The present disclosure provides technology for improving technology for performing passenger transportation using a vehicle.

An information processing method according to an embodiment of the present disclosure is a method executed by an information processing device, the method including acquiring a vehicle dispatch request from a user, via a terminal device, acquiring movement information regarding an amount of movement of the user, deciding a boarding position at which the user is to board a vehicle, based on a current position of the user and the movement information, and deciding an operation plan of the vehicle such that the vehicle heads for the boarding position.

In the above information processing method, the movement information may include an insufficiency value obtained by subtracting a current value from a target value of the amount of movement of the user, and the information processing device may decide a position that is removed from the current position of the user by a distance equal to a target distance decided based on the insufficiency value, as the boarding position.

In the information processing method, the target distance may be decided such that the larger the insufficiency value is, the longer the target distance is.

In the information processing method, the vehicle dispatch request may include information indicating a destination of travel of the user, and the target distance may be decided such that the target distance is shorter than a distance from the current position of the user to the destination.

In the information processing method, the target distance may be decided such that a distance from the boarding position to the destination is no less than a predetermined lower limit value.

In the information processing method, the target distance may be decided such that A+B−C or (A+B)/C is smaller than a predetermined threshold value in which A represents the target distance, B represents the distance from the boarding position to the destination, and C represents the distance from the current position of the user to the destination.

The information processing method may further include selecting, from a plurality of candidate vehicles, one candidate vehicle that is able to arrive at the boarding position earlier than or substantially at the same time as the user, as the vehicle.

An information processing device according to another embodiment of the present disclosure is an information processing device including a control unit, the control unit acquiring a vehicle dispatch request from a terminal device of a user, acquiring movement information regarding an amount of movement of the user, deciding a boarding position at which the user is to board a vehicle, based on a current position of the user and the movement information, and deciding an operation plan of the vehicle such that the vehicle heads for the boarding position.

A non-transitory storage medium according to another embodiment of the present disclosure is a non-transitory storage medium storing instructions that are executable by one or more processors and that cause the one or more processors to perform functions including acquiring a vehicle dispatch request from a terminal device of a user, acquiring movement information regarding an amount of movement of the user, deciding a boarding position at which the user is to board a vehicle, based on a current position of the user and the movement information, and deciding an operation plan of the vehicle such that the vehicle heads for the boarding position.

According to one embodiment of the present disclosure, technology for performing passenger transportation using a vehicle is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a system according to an embodiment of the present disclosure;

FIG. 2 is a block diagram illustrating a schematic configuration of a terminal device;

FIG. 3 is a block diagram illustrating a schematic configuration of an information processing device;

FIG. 4 is a sequence diagram showing operations of the system; and

FIG. 5 is a schematic diagram showing an example of the positional relationship among a current position of a user, a boarding position, and a destination.

### DETAILED DESCRIPTION OF EMBODIMENTS

An embodiment of the present disclosure will be described below.

### Overview of Embodiment

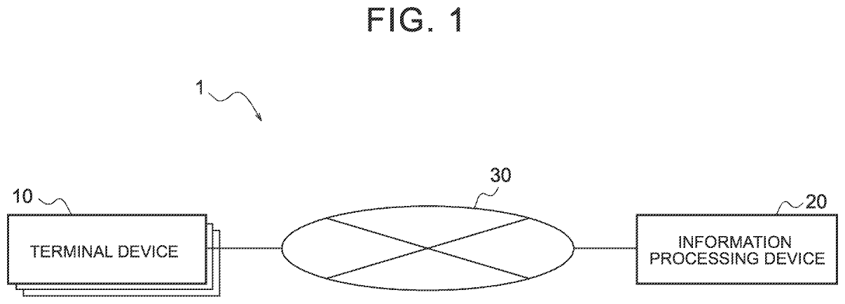

An overview of a system 1 according to an embodiment of the present disclosure will be described with reference to FIG. 1. The system 1 includes a terminal device 10 and an information processing device 20. The terminal device 10 and the information processing device 20 are communicably connected to a network 30 including, for example, the Internet, a mobile communication network, and so forth.

The terminal device 10 is any device used by a user. For example, general-purpose electronic equipment such as a smartphone or a tablet terminal, or dedicated electronic equipment, can be employed as the terminal device 10. In the present embodiment, the number of terminal devices 10 provided to the system 1 may be one or more.

The information processing device 20 is, for example, a server device, but the information processing device 20 is not limited to this, and may be any computer. The information processing device 20 is capable of communicating with the terminal device 10 via the network 30.

First, the overview of the present embodiment will be described, and details of the present embodiment will be described later. The information processing device 20 acquires a vehicle dispatch request from the user via the terminal device 10. The information processing device 20 acquires movement information regarding the amount of movement of the user. The information processing device 20 decides a boarding position at which the user will board the vehicle, based on the current position and movement information of the user. The information processing device 20 then decides an operation plan of the vehicle such that the vehicle heads for the boarding position.

Thus, according to the present embodiment, the boarding position at which the user boards the vehicle is decided based on the current position and the movement information of the user. For example, when a position that is removed from the current position of the user is decided for the boarding position, an increase in the amount of movement of the user is promoted. On the other hand, when a position close to the current position of the user is decided for the boarding position, increase in the amount of movement of the user is suppressed. Accordingly, the technology of performing passenger transportation using a vehicle is improved with regard to a point in that the amount of movement of the user can be controlled to a certain degree.

Next, the configurations of the system 1 will be described in detail.

### Configuration of Terminal Device

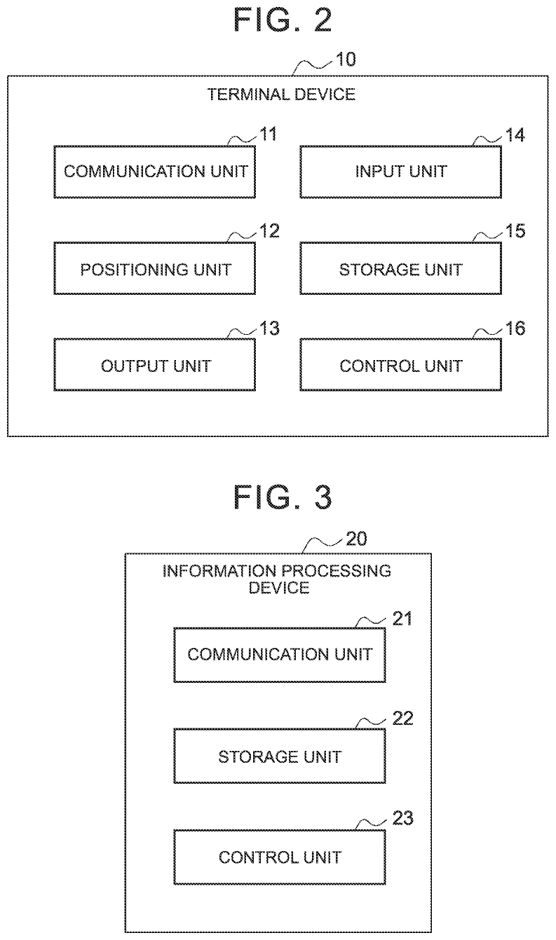

As illustrated in FIG. 2, the terminal device 10 includes a communication unit 11, a positioning unit 12, an output unit 13, an input unit 14, a storage unit 15, and a control unit 16.

The communication unit 11 includes one or more communication interfaces connected to the network 30. The communication interface supports mobile communication standards, for example, 4th generation (4G), 5th generation (5G), and the like, note however that the supported standards are not limited thereto, and may support any communication standard. In the present embodiment, the terminal device 10 communicates with the information processing device 20 via the communication unit 11 and the network 30.

The positioning unit 12 includes one or more devices that acquire position information of the terminal device 10. Specifically, the positioning unit 12 includes, for example, a receiver handling the Global Positioning System (GPS), but is not limited to this, and may include a receiver that handles any satellite positioning system. In the present embodiment, the terminal device 10 is carried by the user, and the position information of the terminal device 10 is treated as the position information of the user.

The output unit 13 may include one or more output devices that output information to notify the user. The output device is, for example, a display that outputs information as images, a speaker that outputs information as audio, and so forth, but is not limited thereto. The output unit 13 may include an interface for connecting an external output device.

The input unit 14 may include one or more input devices that detect user input. The input device is, for example, physical keys, capacitive keys, a touch screen integrated with a display, a microphone that receives voice input, a camera, or the like, but is not limited thereto. The input unit 14 may include an interface for connecting an external input device.

The storage unit 15 includes one or more memory devices. The memory is, for example, semiconductor memory, magnetic memory, optical memory, or the like, but is not limited thereto. Each memory device included in the storage unit 15 may function as, for example, a main storage device, an auxiliary storage device, or cache memory. The storage unit 15 stores any information to be used for operation of the terminal device 10. For example, the storage unit 15 may store a system program, an application program, embedded software, and so forth. The information stored in the storage unit 15 may be updatable by, for example, information acquired from the network 30 via the communication unit 11.

The control unit 16 includes one or more processors, one or more programmable circuits, one or more dedicated circuits, or a combination thereof. The processor is, for example, a general-purpose processor such as a central processing unit (CPU) or a graphics processing unit (GPU), or a dedicated processor specialized for a particular process, but is not limited thereto. The programmable circuit is, for example, a field-programmable gate array (FPGA), but is not limited thereto. The dedicated circuit is, for example, an application specific integrated circuit (ASIC), but is not limited thereto. The control unit 16 controls the overall operations of the terminal device 10.

### Configuration of Information Processing Device

As illustrated in FIG. 3, the information processing device 20 includes a communication unit 21, a storage unit 22, and a control unit 23.

The communication unit 21 includes one or more communication interfaces connected to the network 30. The communication interface supports, for example, a mobile communication standard, a wired local area network (LAN) standard, or a wireless LAN standard, note however that the standard that the communication interface supports is not limited thereto, and may support any communication standard. In the present embodiment, the information processing device 20 communicates with the terminal device 10 via the communication unit 21 and the network 30.

The storage unit 22 includes one or more memory devices. Each memory device included in the storage unit 22 may function as, for example, a main storage device, an auxiliary storage device, or cache memory. The storage unit 22 stores any information to be used for operation of the information processing device 20. For example, the storage unit 22 may store a system program, an application program, a database, map information, and so forth. The information stored in the storage unit 22 may be updatable by, for example, information acquired from the network 30 via the communication unit 21.

The control unit 23 includes one or more processors, one or more programmable circuits, one or more dedicated circuits, or a combination thereof. The control unit 23 controls the overall operation of the information processing device 20.

### Operation Flow of System

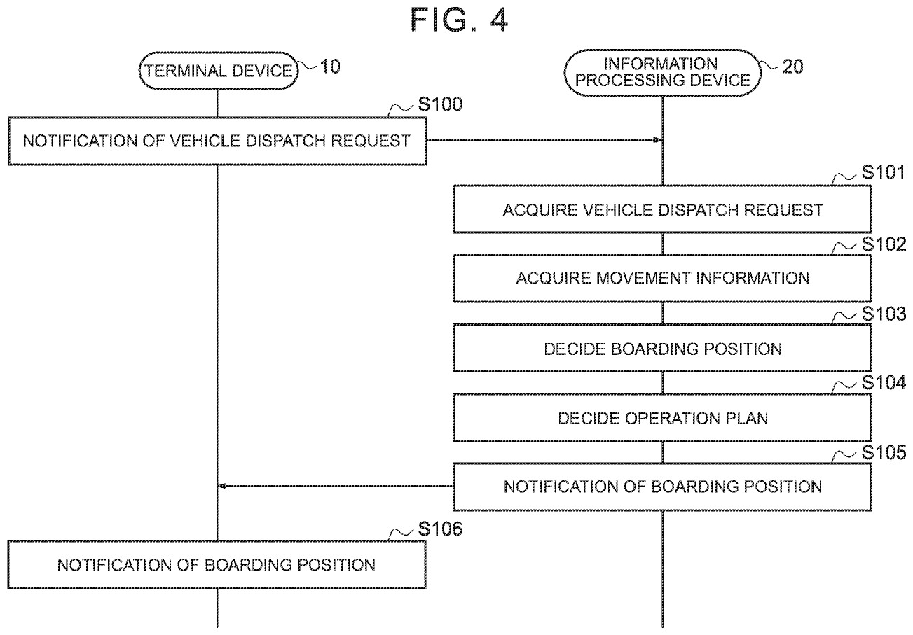

Operation of the system 1 according to the present embodiment will be described with reference to FIG. 4.

Step S100: Upon detecting a particular operation by the user, the control unit 16 of each terminal device 10 notifies the information processing device 20 of a vehicle dispatch request. Description will be made here assuming that one terminal device 10 notifies the information processing device 20 of the vehicle dispatch request.

Specifically, the control unit 16 detects that a particular operation has been executed by the user, based on the user input to the input unit 14. The particular operation may include, for example, an operation of activating a dedicated application program for notification of the vehicle dispatch request, an operation of the user approving the notification of the vehicle dispatch request, and so forth, but the operation is not limited thereto, and any operation may be included. Upon detecting this operation, the control unit 16 transmits a signal indicating a vehicle dispatch request from the user to the information processing device 20, via the communication unit 11 and the network 30.

The signal indicating the vehicle dispatch request from the user includes the position information of the current position of the user. The signal indicating the vehicle dispatch request from the user may further include information indicating the destination of the travel of the user. The signal indicating the vehicle dispatch request from the user may further include authentication information of the user. The authentication information of the user is, for example, account information including a user ID and password, or biometric information including an image such as a face, a fingerprint, blood veins, an iris, or the like, but is not limited thereto. The biometric information of the user can be acquired using, for example, the camera of the input unit 14.

Step S101: The control unit 23 of the information processing device 20 acquires the vehicle dispatch request from the user via the terminal device 10.

Specifically, the control unit 23 receives the signal indicating the vehicle dispatch request from the user, from the terminal device 10 via the communication unit 21 and the network 30.

Step S102: The control unit 23 acquires movement information regarding the amount of movement of the user.

The movement information includes, for example, an insufficiency value obtained by subtracting the current value from the target value of the amount of movement of the user. The amount of movement is an optional degree indicating the amount of movement of the user. For example, the number of steps, the amount of calories burned, or the like, can be employed as the amount of movement. Any method can be employed for acquiring movement information. For example, an arrangement may be made in which the control unit 23 receives, from a wearable device worn by the user via the terminal device 10, a target value set in the wearable device in advance, and a current value of the amount of movement of the user measured by the wearable device, and subtracts the current value from the target value, thereby acquiring the insufficiency value. Alternatively, the control unit 23 may acquire the insufficiency value directly from the wearable device or the terminal device 10 of the user.

Step S103: The control unit 23 decides the boarding position at which the user will board the vehicle, based on the current position and movement information of the user.

Any method can be employed to decide the boarding position. For example, the control unit 23 may decide the target distance based on the insufficiency value obtained by subtracting the current value from the target value of the amount of movement of the user. The control unit 23 may decide a position that is removed from the current position of the user by a distance equal to the decided target distance, as the boarding position.

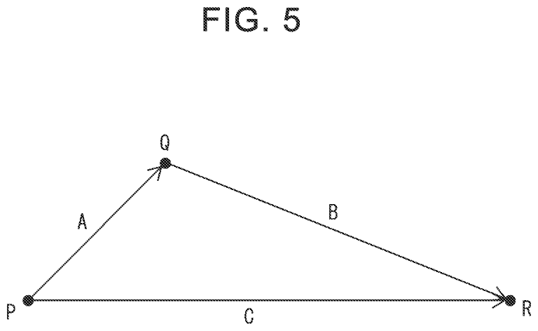

FIG. 5 is a diagram schematically illustrating a specific example of a current position P of the user, a boarding position Q, and a destination R. In FIG. 5, the routes among P, Q, and R are each straight lines in the illustration for the sake of convenience of description, but the routes among P, Q, and R may each follow roads on a map. The distance between the current position P and the boarding position Q (i.e., target distance) may also be written as A, the distance between the boarding position Q and the destination R as B, and the distance between the current position P and the destination R as C, in the following description. When deciding the target distance A and the boarding position Q, the current position P, the destination R, and the distance C from the current position P to the destination R, are constants.

Here, the greater the insufficiency value of the amount of movement of the user is, the longer the target distance A set by the control unit 23 may be. In such a case, the more insufficient the amount of movement of the user is, the farther away from the current position P the boarding position Q is decided to be, thereby promoting increase in the amount of movement of the user.

Further, the control unit 23 may make the target distance A to be shorter than the distance C from the current position P of the user to the destination R. In such a case, an inconvenience, in which the travel time is longer when the user rides the vehicle than when the user travels from the current position P to the destination R on foot, for example, can be suppressed.

Also, the control unit 23 may decide the target distance A and the boarding position Q such that the distance B from the boarding position Q to the destination R is no less than a predetermined lower limit value. In such a case, for example, the likelihood of the travel distance in the vehicle (i.e., the distance B from the boarding position Q to the destination R) becoming extremely short, thereby irritating the user, can be reduced.

Also, the control unit 23 may decide the target distance A and the boarding position Q such that A+B−C or (A+B)/C is below a predetermined threshold value. In such a case, an inconvenience, in which the distance A+B when traveling from the current position P to the destination R via the boarding position Q becomes excessively longer than the distance C when traveling directly from the current position P to the destination R (i.e., becomes a roundabout route), can be suppressed.

Step S104: The control unit 23 decides the operation plan of the vehicle, such that the vehicle heads for the boarding position Q in step S103.

Specifically, the control unit 23 acquires the travel route up to the vehicle arriving at the boarding position Q, and the estimated time of arrival of the vehicle arriving at the boarding position Q. The vehicle is, for example, a passenger vehicle such as an on-demand bus, taxi, or the like, but is not limited thereto. A commonly-used route search technique can be employed for acquiring the travel route and the estimated time of arrival. The control unit 23 decides an operation plan including the acquired travel route and the estimated time of arrival. The vehicle operation plan includes, for example, information indicating a future travel route of the vehicle and the position of the vehicle at each of a plurality of times of day, but is not limited thereto, and may include any information regarding the operation of the vehicle. The vehicle is operated by automatic driving or manual driving by a driver, so as to head for the boarding position according to the operation plan decided by the information processing device 20.

Now, when there are a plurality of candidate vehicles, the control unit 23 may select one candidate vehicle that can arrive at the boarding position Q earlier than the user or at substantially the same time, from among the candidate vehicles, as the above vehicle. Specifically, the control unit 23 acquires the predicted time when the user will arrive at the boarding position Q by a predetermined mode of transport (for example, walking), and one candidate vehicle that can arrive at the boarding position Q earlier than or substantially at the same time as the predicted time is selected as the above vehicle. The control unit 23 decides the operation plan for the selected vehicle, as described above.

Step S105: The control unit 23 notifies the terminal device 10 of the boarding position Q of the vehicle acquired in step S104.

Specifically, the control unit 23 transmits information indicating the boarding position Q of the vehicle to the terminal device 10 via the communication unit 21 and the network 30.

Step S106: The control unit 16 of the terminal device 10 notifies the user of the boarding position Q via the output unit 13.

As described above, the information processing device 20 according to the present embodiment acquires a vehicle dispatch request from the user via the terminal device 10. The information processing device 20 acquires movement information regarding the amount of movement of the user. The information processing device 20 decides a boarding position at which the user will board the vehicle, based on the current position and movement information of the user. The information processing device 20 then decides an operation plan of the vehicle such that the vehicle heads for the boarding position.

According to this configuration, the boarding position at which the user boards the vehicle is decided based on the current position and the movement information of the user. For example, when a position that is removed from the current position of the user is decided for the boarding position, an increase in the amount of movement of the user is promoted. On the other hand, when a position close to the current position of the user is decided for the boarding position, increase in the amount of movement of the user is suppressed. Accordingly, the technology of performing passenger transportation using a vehicle is improved with regard to a point in that the amount of movement of the user can be controlled to a certain degree.

Although the present disclosure has been described above based on the drawings and the embodiment, it should be noted that one skilled in the art can make various modifications and alterations thereto based on the present disclosure. It should be noted, therefore, that these modifications and alterations are within the scope of the present disclosure. For example, the functions and so forth included in the components, the steps, and so forth, can be rearranged so as not to be logically inconsistent, and a plurality of components, steps, and so forth, can be combined into one, or be divided.

For example, in the above embodiment, the configuration and operation of the information processing device 20 may be distributed among a plurality of computers capable of communicating with each other.

Also, an embodiment may be made in which a general-purpose computer, for example, functions as the terminal device 10 or the information processing device 20 according to the above embodiment. Specifically, a program, in which are described processing contents for realizing the functions of the terminal device 10 or the information processing device 20 according to the above-described embodiment, is stored in memory of a general-purpose computer, and the program is read out and executed by a processor. Accordingly, the disclosure according to the present embodiment can also be realized as a non-transitory storage medium storing instructions that are executable by one or more processors and that cause the one or more processors to perform the above functions.

What is claimed is:

1. An information processing method executed by an information processing device, the method comprising:
acquiring a vehicle dispatch request from a user, via a terminal device;
acquiring movement information regarding an amount of movement of the user;
deciding a boarding position at which the user is to board a vehicle, based on a current position of the user and the movement information; and
deciding an operation plan of the vehicle such that the vehicle heads for the boarding position.

2. The information processing method according to claim 1, wherein:
the movement information includes an insufficiency value obtained by subtracting a current value from a target value of the amount of movement of the user; and
the information processing device decides a position that is removed from the current position of the user by a distance equal to a target distance decided based on the insufficiency value, as the boarding position.

3. The information processing method according to claim 2, wherein the target distance is decided such that the larger the insufficiency value is, the longer the target distance is.

4. The information processing method according to claim 2, wherein:
the vehicle dispatch request includes information indicating a destination of travel of the user; and
the target distance is decided such that the target distance is shorter than a distance from the current position of the user to the destination.

5. The information processing method according to claim 4, wherein the target distance is decided such that a distance from the boarding position to the destination is no less than a predetermined lower limit value.

6. The information processing method according to claim 4, wherein the target distance is decided such that A+B−C or (A+B)/C is smaller than a predetermined threshold value in which A represents the target distance, B represents the distance from the boarding position to the destination, and C represents the distance from the current position of the user to the destination.

7. The information processing method according to claim 1, further comprising selecting, from a plurality of candidate vehicles, one candidate vehicle that is able to arrive at the boarding position earlier than or substantially at the same time as the user, as the vehicle.

8. An information processing device comprising a control unit, wherein the control unit is configured to:
acquire a vehicle dispatch request from a terminal device of a user;
acquire movement information regarding an amount of movement of the user,
decide a boarding position at which the user is to board a vehicle, based on a current position of the user and the movement information; and
decide an operation plan of the vehicle such that the vehicle heads for the boarding position.

9. The information processing device according to claim 8, wherein:
the movement information includes an insufficiency value obtained by subtracting a current value from a target value of the amount of movement of the user; and
the control unit is configured to decide a position that is removed from the current position of the user by a distance equal to a target distance decided based on the insufficiency value, as the boarding position.

10. The information processing device according to claim 9, wherein the target distance is decided such that the larger the insufficiency value is, the longer the target distance is.

11. The information processing device according to claim 9, wherein:
the vehicle dispatch request includes information indicating a destination of travel of the user; and
the target distance is decided such that the target distance is shorter than a distance from the current position of the user to the destination.

12. The information processing device according to claim 11, wherein the target distance is decided such that a distance from the boarding position to the destination is no less than a predetermined lower limit value.

13. The information processing device according to claim 11, wherein the target distance is decided such that A+B−C or (A+B)/C is smaller than a predetermined threshold value in which A represents the target distance, B represents the distance from the boarding position to the destination, and C represents the distance from the current position of the user to the destination.

14. The information processing device according to claim 8, wherein the control unit is configured to select, from a plurality of candidate vehicles, one candidate vehicle that is able to arrive at the boarding position earlier than or substantially at the same time as the user, as the vehicle.

15. A non-transitory storage medium storing instructions that are executable by one or more processors and that cause the one or more processors to perform functions comprising:
acquiring a vehicle dispatch request from a terminal device of a user;
acquiring movement information regarding an amount of movement of the user;
deciding a boarding position at which the user is to board a vehicle, based on a current position of the user and the movement information; and
deciding an operation plan of the vehicle such that the vehicle heads for the boarding position.

16. The non-transitory storage medium according to claim 15, wherein:
the movement information includes an insufficiency value obtained by subtracting a current value from a target value of the amount of movement of the user; and
the instructions further cause the one or more processors to perform deciding of a position that is removed from the current position of the user by a distance equal to a target distance decided based on the insufficiency value, as the boarding position.

17. The non-transitory storage medium according to claim 16, wherein the target distance is decided such that the larger the insufficiency value is, the longer the target distance is.

18. The non-transitory storage medium according to claim 16, wherein:
the vehicle dispatch request includes information indicating a destination of travel of the user; and
the target distance is decided such that the target distance is shorter than a distance from the current position of the user to the destination.

19. The non-transitory storage medium according to claim 18, wherein the target distance is decided such that a distance from the boarding position to the destination is no less than a predetermined lower limit value.

20. The non-transitory storage medium according to claim 18, wherein the target distance is decided such that A+B−C or (A+B)/C is smaller than a predetermined threshold value in which A represents the target distance, B represents the distance from the boarding position to the destination, and C represents the distance from the current position of the user to the destination.
